(19) United States
(12) Patent Application Publication
(10) Pub. No.: US 2014/0350923 A1
(43) Pub. Date: Nov. 27, 2014

(54) METHOD AND DEVICE FOR DETECTING NOISE BURSTS IN SPEECH SIGNALS

(71) Applicant: Tencent Technology (Shenzhen) Co., Ltd., Shenzhen (CN)

(72) Inventor: Xiaoping WU, Shenzhen (CN)

(73) Assignee: Tencent Technology (Shenzhen) Co., Ltd., Shenzhen (CN)

(21) Appl. No.: 14/162,300

(22) Filed: Jan. 23, 2014

Related U.S. Application Data
(63) Continuation of application No. PCT/CN2013/087787, filed on Nov. 25, 2013.

(30) Foreign Application Priority Data
May 23, 2013 (CN) 2013101950806

(51) Int. Cl. G10L 25/87

(52) U.S. Cl. CPC G10L 25/87
USPC 704/226

(57) ABSTRACT

A method and device for detecting noise bursts in speech signals are disclosed. The method including: partitioning a section of speech signals to be detected into a plurality of speech frames, performing in each of the plurality of speech frames: Fast Fourier Transform (FFT) processing in frequency-domain, afterwards computing across an entire frequency range, an energy value corresponding to each of the frequency point; utilizing the computed energy value to compute a mean energy value of the speech frame; computing a low frequency range mean energy value; performing clustering analysis on the low frequency range mean energy value over the plurality of speech frames; determining a range of strong energy value based on the clustering analysis result; detecting whether the mean energy value falls within the range of strong energy value; if so: indicating that the section of speech signals to be detected has a noise burst.

### CROSS-REFERENCE TO RELATED APPLICATIONS

This application is a continuation of PCT Application No. PCT/CN2013/087787, filed on Nov. 25, 2013, which claims priority to Chinese Patent Application No. 2013101950806, filed on May 23, 2013, which is incorporated by reference in their entireties.

### FIELD OF THE TECHNOLOGY

The present disclosure relates generally to speech signals detection and, more particularly, to a method and apparatus for detecting noise bursts in speech signals.

### BACKGROUND

To better understand the present disclosure, below is a brief definition of the terminologies which may be used throughout the description to provide general understanding. They do not represent authoritative definitions. If there is any conflict in meaning with the ordinary meaning from a dictionary, the following definitions may take precedence.

Noise burst: a noise burst is an irritating sound caused by high energy values in various frequency ranges.

Speech spectrograph: a speech spectrograph is a graph with its horizontal axis representing time duration of speech, and its vertical axis representing a range of frequency points from low to high frequencies within a speech frame. The energy value at each time point and at each frequency point in frequency domain is denoted by a color range. The higher the energy value in frequency domain, the deeper or darker the color, and the lower the energy value in frequency domain, the lighter the color.

At present, noise bursts in speech signals are mostly detected by ear manually, which may be time consuming and the occurrence of noise bursts locations may not be precisely located.

### SUMMARY

To overcome the prior art method of relying on ears to manually detect noise burst in speech signals, the present disclosure provides a method and device for detecting noise bursts in speech signals. The technical scheme is as follows:

The present disclosure provides a method and apparatus for detecting noise bursts, which detection may be automated in various implementations.

In an aspect of the disclosure, the method for detecting noise bursts, may include: partitioning a section of speech signals to be detected into a plurality of speech frames, and performing the following in each of the plurality of speech frames:

Fast Fourier Transform (FFT) processing to frequency-domain, afterwards computing across an entire frequency range, an energy value corresponding to each of the frequency point; utilizing the computed energy value corresponding to each of the frequency point to compute a mean energy value of the speech frame across the entire frequency range; computing a low frequency range mean energy value for the speech frame; using a clustering algorithm, performing clustering analysis on the low frequency range mean energy value over the plurality of speech frames in the section of speech signals; determining a range of strong energy value based on the clustering analysis result; detecting whether the mean energy value in each of the plurality of speech frames across the entire frequency range falls within the range of strong energy value; if it has been detected that the mean energy value in at least one speech frame out of the plurality of speech frames in the section of speech signals falls within the range of strong energy value: confirming or indicating that the section of speech signals to be detected has a noise burst; otherwise, confirming or indicating that the section of speech signals to be detected does not have a noise burst.

In an aspect of the disclosure, the apparatus for detecting noise bursts, may include at least a processor operating in conjunction with a memory and a plurality of units, wherein the plurality of units may include: a partition unit which performs the function of partitioning a section of speech signals to be detected into a plurality of speech frames; a processing unit which performs the functions of Fast Fourier Transform (FFT) processing in frequency-domain, afterwards computing across an entire frequency range, an energy value corresponding to each of the frequency point;

a computation unit which performs the functions of utilizing the computed energy value corresponding to each of the frequency point to compute a mean energy value of the speech frame across the entire frequency range; computing a low frequency range mean energy value for the speech frame, E1; a cluster unit using a clustering algorithm, performs the functions of performing clustering analysis on the low frequency range mean energy value over the plurality of speech frames in the section of speech signals; and determining a range of strong energy value based on the clustering analysis result; a detection unit which performs the functions of detecting whether the mean energy value in each of the plurality of speech frames across the entire frequency range falls within the range of strong energy value; if it has been detected that the mean energy value in at least one speech frame out of the plurality of speech frames in the section of speech signals falls within the range of strong energy value: confirming or indicating that the section of speech signals to be detected has a noise burst; otherwise, confirming or indicating that the section of speech signals to be detected does not have a noise burst.

The present disclosure detects the intensity of a section of speech signal and computes a mean energy value in each speech frame over the entire frequency range of the speech frame, and detects whether a noise burst exists in the section of speech signal. The method may be implemented using a device to automatically detect noise bursts in each section of speech signals thus enable correction of the noise bursts problems by a system before being heard by a user, thus enhance user's experience.

### BRIEF DESCRIPTION OF THE DRAWINGS

The accompanying drawings are included to provide a further understanding of the claims and disclosure, are incorporated in, and constitute a part of this specification. The detailed description and illustrated embodiments described serve to explain the principles defined by the claims.

FIG. 1 depicts an exemplary system implementing noise bursts detection in speech signals, according to the present disclosure.

FIG. 2A depicts an occurrence of noise bursts as illustrated in a spectrograph of a speech frame, according to the present disclosure.

FIG. 2B illustrates a location of detected noise burst as depicted by the speech frame of FIG. 2A, according to the present disclosure.

FIG. 3 is a flow diagram illustrating an exemplary method for detecting noise bursts in speech signals, according to the present disclosure.

FIG. 4 is a flow diagram illustrating an exemplary clustering analysis algorithm used in detecting noise bursts in speech signals, according to the present disclosure.

FIG. 5 illustrates an exemplary schematic block diagram of an embodiment of the noise bursts detection device, according to the present disclosure.

### DETAILED DESCRIPTION OF THE EMBODIMENTS

The various embodiments of the present disclosure are further described in details in combination with attached drawings and embodiments below. It should be understood that the specific embodiments described here are used only to explain the present disclosure, and are not used to limit the present disclosure.

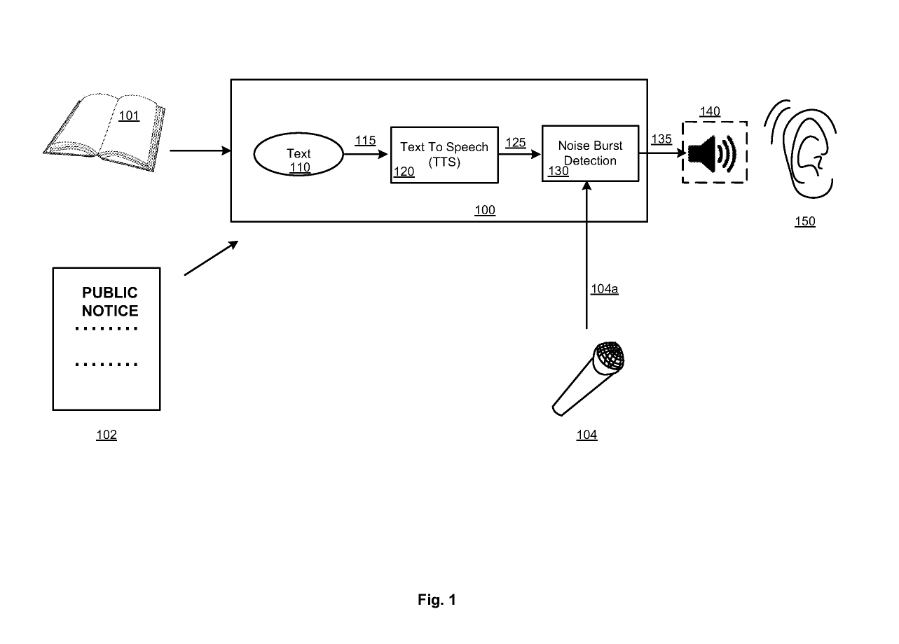

FIG. 1 depicts exemplary system (100) implementing noise bursts detection in speech signals, according to the present disclosure. In an embodiment, the system (100) may be a text to speech human machine interface, having a text input interface (110), a text to speech converter and synthesizer (120), a noise burst detection device (130) and an optionally speech output device, such as a speaker (140) (which may be built in or as a remote peripheral device). The system (100) is of particular interest to consumers, due to their broad applications, such as aiding blind people to read signs and text materials, helping people to learn a new language, or simply allowing people to hear the content of the text in a situation when reading is not convenient.

In an embodiment, the system (100) may be an electronic tablet device, a laptop computer, a desk top computer, a smart phone, a terminal, a human machine interface. In an embodiment, the system (100) may include an optical scanner or a camera which may receive text input through an optical scanner, or through a camera or video, which may take frames of text images. In another embodiment, the system (100) may simply be a device, such as an electronic tablet, a smart phone, a laptop computer, a desk top computer, a terminal, which may process text data stored internally, or text data received through a communication interface.

The text interface (110) may send the text data (115) to the text to speech converter (120), which in turns may generate streams or sections of speech signals (125). Due to system imperfections, generated speech signals (125) during the text to speech conversion (120) process may have variation in energy at various frequencies, which may produce short bursts of noise or sound in an output audio stream (135). Such short bursts of noise (i.e., noise bursts) may be very irritating and uncomfortable when heard by a human ear (150) (such as through the speaker (140)). The present disclosure implements a method and a device (130) (i.e., noise bursts detection device) which allows detection and indication of which speech frame in the speech signals (125) has noise bursts, such that corrections may be implemented on that speech frame to provide a more pleasant user experience when being heard by the human ear (150).

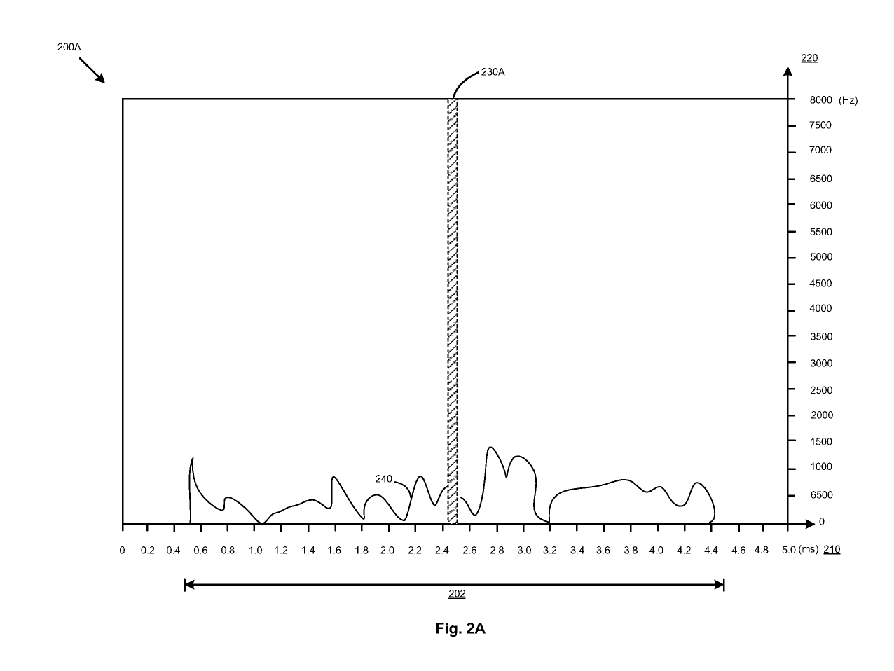

FIG. 2A depicts an occurrence of noise bursts (230A) as illustrated in a spectrograph of a speech frame (200A), according to the present disclosure. In general, a spectrograph is a speech frame captured by an instrument to display the energy state of the speech signals over a duration of time (shown as the horizontal axis or x-axis with units in millisecond (ms)), and over a range of frequency (shown as the vertical axis or y-axis with units in hertz (Hz)). The energy carried in the speech signal is displayed as the colorful pattern distribution over time domain and over frequency domains. The higher the energy, the brighter the color intensity, the lower the energy, the dimmer the color intensity.

As shown in FIG. 2A, a pattern of high energy and low energy distribution may be shown by the bright regions and the dark regions, respectively. It should be pointed out that it matters how the high energy region and the low energy region are distributed in each speech frame. More particularly, a high concentration of energy (bright color region) over a broad frequency range (i.e., y-axis) and over a short duration of time (i.e., x-axis) may indicate a characteristic of a noise burst,

A noise burst therefore, exhibits a high energy value (as measured over a full range of frequency) that exceeds a threshold energy value when compared to a strong energy range within the speech frame itself Referring to FIG. 2A, a noise burst (230A) may occur between the duration of time between 2.45-2.48 ms (i.e., shown as bright vertical bar) in the speech frame (200A)

FIG. 2B illustrates a location of detected noise burst as depicted by the speech frame (202) of FIG. 2A, according to the present disclosure. More specifically, FIG. 2B illustrates a simplified spectrograph (200B), has an x-axis of time (210) showing the time frame (0-5 ms), and a y axis (220) showing the frequency range (0-8 kHz).

As seen, a noise burst (230B) may be detected by the method to be discussed, which occurs over time duration between 2.45-2.48 ms, and over a frequency range between 0-8 kHz in the current speech frame. In an embodiment of the disclosure, a low frequency range region (240) may be established (i.e., 0-550 Hz) to compute a low frequency range mean energy value for the speech frame (202).

FIG. 2B also discloses that the speech frame (202) spans between 5 to 45 ms, with a window width (232a, 232b) being added on both sides of the frame to each of the plurality of speech frames, wherein the window width is preset to accommodate a lateral shift movement of the speech frame over time during the partitioning of the section of speech signals into the plurality of speech frames.

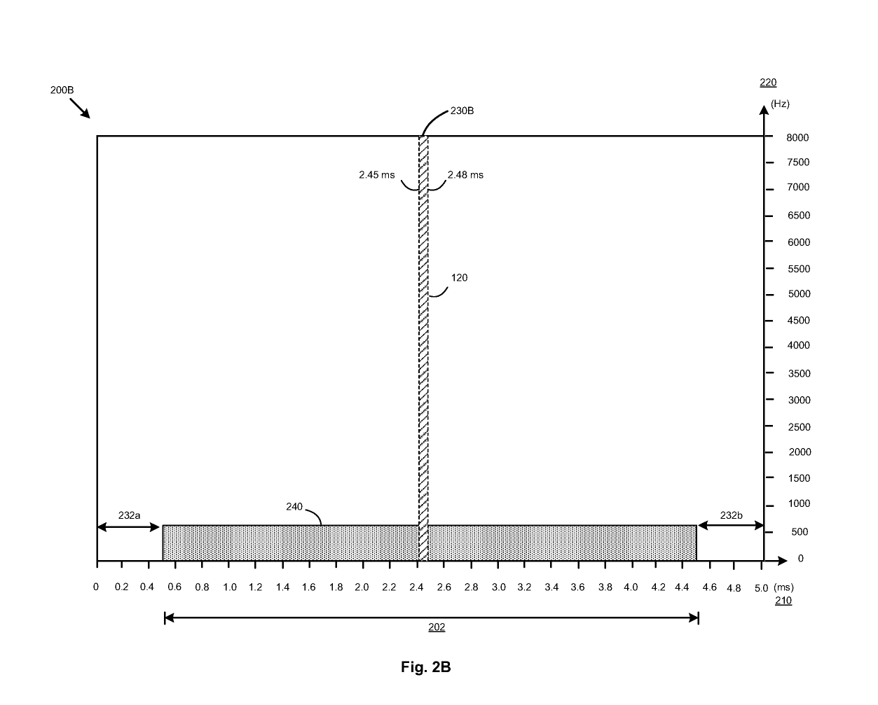

FIG. 3 is a flow diagram illustrating an exemplary method for detecting noise bursts in speech signals, according to the present disclosure. The reference designations in FIGS. 1 to 2B may be referred back for understanding. The method may include the following steps:

Step 301: partitioning a section of speech signals to be detected into a plurality of speech frames. The partitioning step may include using adding window width mode to partition a section of speech signal to be detected into a plurality of speech frames. The speech frame (202) may be partitioned to accommodate translational or lateral speech frame movement over a preset time duration (e.g., 5 ms) on each side of the frame (202). The preset time duration is set as window widths (232a, 232b).

Taking a translation time length or duration of 5 ms, and a speech frame width of 40 ms as an example, a set of speech signals 100 ms in time length may be divided into a plurality of speech frames as follows:
1st speech frame: 0-40 ms;
2nd speech frame: 5 ms-45 ms;
3rd speech frame: 10 ms-50 ms;
4th speech frame: 15 ms-55 ms; and so on.
The last second speech frame: 55 ms-95 ms; the last speech frame: 60 ms-100 ms.

Step 302: performing the following in each of the plurality of speech frames: perform Fast Fourier Transform (FFT) processing to frequency-domain, afterwards computing across an entire frequency range, an energy value corresponding to each of the frequency point.

In the present disclosure, the number of sampling points in each speech frame is: t*fs, where t is the frame length, and fs is the sampling frequency. In an embodiment of the present disclosure, t is 0.04 s (i.e. 40 ms), fs is 16000 and accordingly, the number of sampling points is 0.04*16000=640.

Based on this, Step 302 may perform fast Fourier transform (FFT) processing on each speech frame at more than 640 sampling points (e.g. 1024 sampling points), and computing a logarithmic value of an amplitude corresponding to each frequency point across the entire frequency range of the speech frame; and setting the computed logarithmic value of the amplitude corresponding to each frequency point of as the energy value corresponding to the frequency point.

Step 303: utilizing the computed energy value corresponding to each of the frequency point to compute a mean energy value (E0) of the speech frame across the entire frequency range. Taking a full frequency range of 0-8 kHz as an example, Step 303 adds the frequency-domain energy value of each speech frame in the 0-8 kHz frequency range, and divides the sum by the total number of frequency points in the 0-8 kHz frequency range to obtain the mean energy value (E0) of the speech frame (i.e., 5-45 ms) over the full frequency range (i.e., 0-8 kHz).

Step 304: computing a low frequency range (0-550 Hz) mean energy value (E1) for the speech frame. As the intensity distribution of each speech signal is different, comparison of the intensity distribution of each speech signal may only be made with respect to the speech signal itself High-energy and low-energy distribution and typical parameters are significant only for the speech signal itself

It is infeasible to define with respect to all speech signals that an energy value larger than a certain value (i.e., threshold) is a strong energy and that an energy value smaller than a certain value is a weak energy. It is also feasible to define with respect to a certain speech signal that an energy value larger than a certain value belongs to the strong energy range of that section of speech signal and that an energy value smaller than a certain value belongs to the weak energy range of that section of speech signal.

According to speech characteristics, a speech that is not completely silent (completely silence speech is of little significance) always has two zones - a strong zone and a weak zone, especially in a low frequency range (i.e., 0-550 Hz). Based on this, the present disclosure divides a speech into a strong zone and a weak zone by computing the low frequency range mean energy values (E1) of all the speech frames over the low frequency range (i.e., 0-550 Hz) (refer to Steps 305), for subsequent detection of noise burst (refer to Step 306).

Step 305: using a clustering algorithm, performing clustering analysis on the low frequency range mean energy value (E1) over the plurality of speech frames in the section of speech signals, determining a range of strong energy value based on the clustering analysis result.

Clustering is a process whereby the low frequency range mean energy values (E1), are classified or clustered, so that the low frequency range mean energy values, (E1) in the same class or cluster have a high similarity (i.e., shortest distance to the cluster center). In this embodiment, two clusters may be established such that each cluster itself may contain only highly similar low frequency range mean energy values (E1). In this regard, the two clusters are opposite and highly dissimilar from each other in low frequency range mean energy values (El).

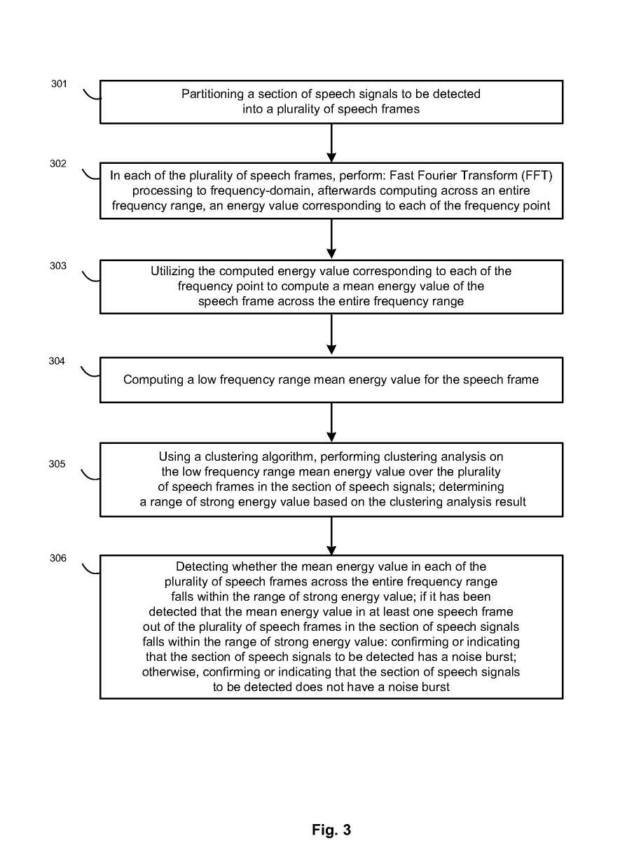

In an embodiment of the present disclosure, Step 305 uses K-means clustering method to perform cluster analysis on the low frequency range mean energy values (El) of all speech frames. The clustering analysis may be described in the following FIG. 4.

Step 306: detecting whether the mean energy value (E0) in each of the plurality of speech frames across the entire frequency range (0-8 kHz) falls within the range of strong energy value; if it has been detected that the mean energy value in at least one speech frame out of the plurality of speech frames in the section of speech signals falls within the range of strong energy value: confirming or indicating that the section of speech signals to be detected has a noise burst; otherwise, confirming or indicating that the section of speech signals to be detected does not have a noise burst.

FIG. 4 is a flow diagram illustrating an exemplary clustering analysis algorithm used in detecting noise bursts in speech signals, according to the present disclosure. Referring to FIG. 4, which is a process flow diagram of an embodiment of the cluster analysis on values low frequency range mean energy values (E1) of all the speech frames according to the present disclosure, the process comprising the following steps:

Step 401: randomly selecting any two low frequency range mean energy values out of the plurality of the speech frames to be a first and a second current clustering centers for establishing a first cluster and a second cluster, respectively. Furthermore, the first and the second current cluster centers are utilized to establish a first cluster and a second cluster, respectively, such that the first cluster comprises corresponding low frequency range mean energy values which form the shortest distance to the first current cluster center, and the second cluster comprises corresponding low frequency range mean energy values which form the shortest distance to the second current cluster center.

Step 402: establishing the respective first cluster and the second cluster. For each of the speech frames, computing in absolute values, a first corresponding distance by taking a difference of energy values between the first current cluster center and the low frequency range mean energy value corresponding to a first speech frame, and computing in absolute values, a second corresponding distance by taking a difference of energy values between the second current cluster center and the low frequency range mean energy value corresponding to the same first speech frame.

Subsequent to the computing, sorting the low frequency range mean energy value of the first speech frame to belong one of the first cluster or the second cluster by comparing the first corresponding distance with the second corresponding distance: if the first corresponding distance is shorter, the low frequency range mean energy value of the first speech frame belongs to the first cluster, if the second corresponding distance is shorter, the low frequency range mean energy value of the first speech frame belongs to the second cluster, if the first corresponding distance being the same as the second corresponding distance, clustering analysis is completed and reporting pending low frequency range mean energy values in the respective first and the second clusters as a result of the clustering analysis.

Step 403 repeat operations in the above step 402 to continue computing in absolute values, the first corresponding distance and the second corresponding distance by taking a difference of energy values between the low frequency range mean energy value corresponding to a subsequent speech frame with the respective first current cluster center and the second current cluster center, and sorting the low frequency range mean energy value of the subsequent speech frame to one of the respective first cluster and the second cluster based on a shorter distance to the first current cluster center or to the second current cluster center, until all the low frequency range mean energy values in all remaining speech frames have been computed by the operations in the above step 402.

Step 404: separately and respectively averaging all the low frequency range mean energy values in the first cluster and in the second cluster to yield a pair of first average low frequency range mean energy value and a second average low frequency range mean energy value, and comparing the pair of the respective first average low frequency range mean energy value and the second average low frequency range mean energy value to the first and the second current clustering centers.

If the pair of the first and the second average low frequency range mean energy value is identical to, or within an error limit of the energy value of the first and the second current clustering centers, the clustering analysis is completed and reporting pending low frequency range mean energy values in the respective first and the second clusters as a result of the clustering analysis, otherwise, setting the respective first average low frequency range mean energy value and the second average low frequency range mean energy value being the first and the second current clustering centers, and repeating the clustering analysis operations in step 2 until the pair of the first and the second average low frequency range mean energy value is identical to, or within an error limit of the energy value of the first and the second current clustering centers.

An example is provided below to illustrate the clustering method, such as a k clustering algorithm. Assuming that in the six speech frames has the following computed low frequency range mean energy values (E1) are 5, 20, 100, 80, 15, 113, respective. Assuming two clusters are to be formed, namely, k1, k2.

Assuming that in step 401, the low frequency range mean energy values 5 and 20 have been randomly selected to be the current first and the second cluster centers, respectively.

In step 402, the first and the second corresponding distances are computed by taking a difference of energy values between the first current cluster center and the low frequency range mean energy value corresponding to the 1st speech frame:
D1=abs (5−5)=0 (shorter distance)
D2=abs (20−5)=15

Since D1≠D2, the clustering analysis operation does not terminate. In addition, since D1<D2 (D1 has the shorter distance), therefore the 1^{st} speech frame low frequency range mean energy value (E1) of 5 is sorted into cluster k1 (having the shortest distance to the first current cluster center 5).

Performing Step 403: Repeat the distance calculation on the 2nd speech frame with E1=20:
D1=abs (5−20)=15
D2=abs (20−20)=15 (shorter)

Since D1≠D2, the clustering analysis operation does not terminate. In addition, since D2<D1 (the shorter distance), therefore the 2nd speech frame low frequency range mean energy value (E1) of 20 is sorted into cluster k2 (having the shortest distance to the first current cluster center 20).

Repeat the distance calculation on the 3^{rd} speech frame, E1=100:
D1=abs (5−100)=85
D2=abs (20−100)=80 (shorter), therefore E1 sorted to cluster k2

Likewise, for 4^{th} speech frames E1=80:
D1=abs (5−80)=75
D2=abs (20−80)=60 (shorter), therefore E1 sorted to cluster k2

Likewise, for 5^{th} speech frames E1=15:
D1=abs (5−15)=10
D2=abs (20−15)=5 (shorter), therefore E1 sorted to cluster k2

Likewise, for 6^{th} speech frames E1=113:
D1=abs (5−113)=108
D2=abs (20−113)=93 (shorter), therefore E1 sorted to cluster k2
cluster k1 low frequency range mean energies (E1) is 5,
cluster k2 low frequency range mean energies (E1) are 20, 100, 80, 15 and 115

Performing Step 404: calculate average E1 in each of k1 and k2
E(1) Avg (k1)=5
E(1) Avg (k2)=(20+100+80+15+113)/5=65.6
Set 5 as current cluster center 1
Set 65.6 as current cluster center 2

Repeat step 402, set E(1)Avg (k1) =5, E(2)Avg (k2)=65.6 as the first and the second corresponding cluster centers, and compute the distances:

For 1^{st} speech frame:
D1=Abs(5−k1)=Abs (5-5)=0 (shorter), therefore E1 sorted to cluster k1
D2=Abs(5−k2)=Abs(5-65.6)=60.6

For 2nd speech frame:
D1=Abs(20-k1)=15 (shorter), therefore E1 sorted to cluster k1
D2=Abs(20-k2)=45.6

Similarly, after computing for 3^{rd} to 6^{th} speech frames:
Low frequency range mean energy value (E1) of cluster k1=5, 20, 15
Low frequency range mean energy value (E1) of cluster k2=100, 80, 113

Performing Step 404: calculate average E1 in each of k1 and k2

E(1) Avg (k1)=(5+20+15)/3=13.333
E(1) Avg (k2)=(100+80+113)/5=97.666
Set 13.333 as current cluster center 1
Set 97.666 as current cluster center 2

Repeat step 402, set E(1)Avg (k1)=13.333, E(2)Avg (k2)=97.666 as the first and the second corresponding cluster centers, and compute the distances:
Low frequency range mean energy value (E1) of cluster k1=5, 20, 15
Low frequency range mean energy value (E1) of cluster k2=100, 80, 113

Performing Step 404: calculate average E1 in each of k1 and k2
E(1) Avg (k1)=(5+20+15)/3=13.333
E(1) Avg (k2)=(100+80+113)/5=97.666
Set 13.333 as current cluster center 1
Set 97.666 as current cluster center 2

Since E(1) Avg=13.333 and E(1) Avg (k2)=97.666 are the as the first and the second current cluster centers from the previous calculation, therefore, the clustering analysis terminated here and the results of clusters k1 and k2 are confirmed.

Therefore, the low frequency range mean energy values for cluster k1 are (5, 20, 15) and the low frequency range mean energy values for cluster k2 are (100, 80 and 113). Cluster k1 represents the range of energy values in the low energy region, and cluster k2 represents the range of energy values of the high energy region of the low frequency range (0-550 Hz).

It should be noted that FIG. 4 only exemplifies the performance of a cluster analysis on the mean energy values of all speech frames over the low frequency range, E1, using K-means clustering method. Preferably, the present disclosure may employ other methods, such as the iterative self-organizing data analysis technique (ISODATA), to perform cluster analysis on the mean energy values of all speech frames over the low frequency range, E1.

The above clustering analysis as shown in FIG. 4 is the detailed description of step 305 “determining a range of strong energy value based on the clustering analysis result”.

Subsequent to the clustering analysis, the step 306 of “detecting whether the mean energy value (E0) in each of the plurality of speech frames across the entire frequency range (0-8 kHz) falls within the range of strong energy value; if it has been detected that the mean energy value in at least one speech frame out of the plurality of speech frames in the section of speech signals falls within the range of strong energy value: confirming or indicating that the section of speech signals to be detected has a noise burst; otherwise, confirming or indicating that the section of speech signals to be detected does not have a noise burst” may be performed.

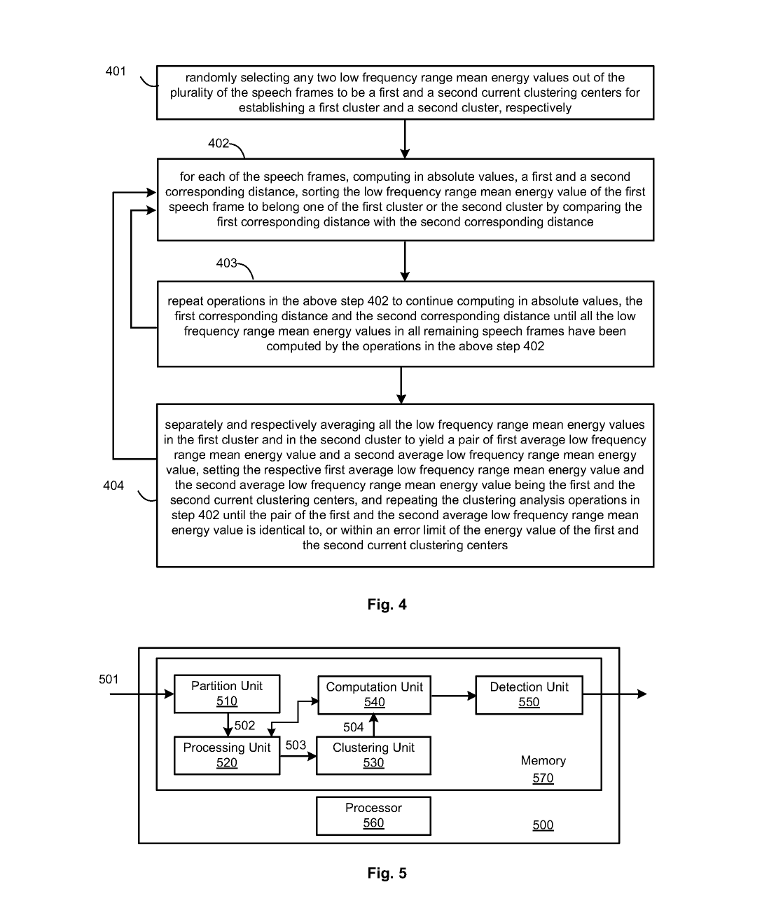

FIG. 5 illustrates an exemplary schematic block diagram of an embodiment of the noise bursts detection device, according to the present disclosure. The device may include at least a processor (550) operating in conjunction with a memory (570) and a plurality of units, wherein the plurality of units include a partition unit (510), a processing unit (520), a clustering unit (530), a computation unit (540) and a detection unit (550).

The partition unit (510) performs the function of partitioning a section of speech signals (501) to be detected into a plurality of speech frames (502). The partition unit (510) also performs adding a window width to each of the plurality of speech frames, wherein the window width is preset to accommodate a lateral shift movement of each speech frame over time during the partitioning of the section of speech signals into the plurality of speech frames.

The processing unit (520) performs the functions of Fast Fourier Transform (FFT) processing in frequency-domain, afterwards computing across an entire frequency range, an energy value E0 (503) corresponding to each of the frequency point on the plurality of speech frames (502).

In an embodiment, the processing unit (520) computes a logarithmic value of an amplitude corresponding to each frequency point across the entire frequency range of the speech frame; and setting the computed logarithmic value of the amplitude corresponding to each frequency point of as the energy value corresponding to the frequency point.

The computation unit (540) performs the functions of utilizing the computed energy value E0 (503) corresponding to each of the frequency point to compute a mean energy value of the speech frame across the entire frequency range. The computing unit (540) then computes a low frequency range mean energy value El over the low frequency for the speech frame.

In an embodiment of the disclosure, the computation unit (540) performs the function of summing the energy value corresponding to each frequency point across the entire frequency range of the speech frame to obtain a first computation result, dividing the first computation result by the total number of frequency points in the entire frequency range to obtain the mean energy value of the speech frame across the entire frequency range.

The computing of the low frequency range mean energy value in the speech frame, including summing the energy value corresponding to each frequency point over a preset low frequency range in the speech frame to obtain a low frequency energy sum value; dividing the low frequency energy sum value by the total number of frequency points in the preset low frequency range to obtain the low frequency range mean energy value of the speech frame.

The clustering unit (530) uses a clustering algorithm, performing clustering analysis on the low frequency range mean energy value (E1) over the plurality of speech frames in the section of speech signals (501), and determining a range of strong energy value (504) based on the clustering analysis result as disclosed in FIG. 4.

The detection unit (550) performs the functions of detecting whether the mean energy value in each of the plurality of speech frames across the entire frequency range falls within the range of strong energy value (504); if it has been detected that the mean energy value in at least one speech frame out of the plurality of speech frames in the section of speech signals falls within the range of strong energy value (504): confirming or indicating that the section of speech signals to be detected has a noise burst; otherwise, confirming or indicating that the section of speech signals to be detected does not have a noise burst.

The clustering unit (530) In another embodiment of the present disclosure, besides the method described in FIG. 4, perform clustering analysis on the mean energy values of all the speech frames over the low frequency range, E1, comprises: Step 1: randomly selecting two mean energy values over the low frequency range , E1, from the mean energy values of all the speech frames over the low frequency range, E1, as the current cluster centers separately; Step 2: computing the distance from each mean energy value over the low frequency range, E1, to each of the current cluster centers; classifying the mean energy values over the low frequency range, E1, into the respective clusters corresponding to the respective current cluster centers at the shortest distance thereto; Step 3: separately computing the respective mean values of all the mean energy values over the low frequency range, E1, in the clusters corresponding to the two current cluster centers; comparing whether the two computed mean values are the same as the two current cluster centers; ending the current process and taking the clusters corresponding to the two computed mean values as the final clustering results if the two computed mean values are the same as the two current cluster centers, and taking the two computed mean values as the current cluster centers and returning to step 2 if the two computed mean values are not the same as the two current cluster centers.

Based on this, the cluster unit's determining the strong energy value range according to the clustering results comprises: selecting from the two clusters taken as the clustering results a cluster which contains the larger mean energy value over the low frequency range, E1, and taking all the mean energy values over the low frequency range, E1, or a part of the mean energy values over the low frequency range, E1, in the selected cluster as the strong energy value range.

The foregoing describes the apparatus provided by the present disclosure.

It can be seen from the aforementioned technical scheme that the present disclosure depicts the intensity of a speech signal to be detected in the full frequency range through the magnitude of the mean energy value of each speech frame over the full frequency range, and detects whether a noise burst exists in the speech signal to be detected according to whether the mean energy values of various speech frames in the full frequency range are in the strong energy value range. The method achieves automatic dynamic detection of noise bursts in a speech signal without having to employ ear detection method of prior art, and thus conserves human resources.

Further, as the energy values of a noise burst in various frequency ranges are relatively high and it shows a “bright vertical stripe” on the spectrograph, the present disclosure detects whether there is any noise burst in a speech signal according to whether the mean energy values of various speech frames over the full frequency range are in the strong energy value range. This is consistent with the characteristics of noise burst and verifies that the present disclosure is logical to detect whether there is any noise burst in a speech signal according to whether the mean energy values of various speech frames over the full frequency range are in the strong energy value range.

Furthermore, since different speech signals are different in intensity distribution the present disclosure determines the strong energy value range used for judging whether a speech signal to be detected is a noise burst so that the determined strong energy value range corresponds to the speech signal to be detected, thereby ensuring more accurate noise burst detection.

It should be understood by those with ordinary skill in the art that all or some of the steps of the foregoing embodiments may be implemented by hardware, or software program codes stored on a non-transitory computer-readable storage medium with computer-executable commands stored within. For example, the disclosure may be implemented as an algorithm as codes stored in a program module or a system with multi-program-modules. The computer-readable storage medium may be, for example, nonvolatile memory such as compact disc, hard drive or flash memory. The said computer-executable commands are used to enable a computer or similar computing device to accomplish the payment validation request operations.

The foregoing represents only some preferred embodiments of the present disclosure and their disclosure cannot be construed to limit the present disclosure in any way. Those of ordinary skill in the art will recognize that equivalent embodiments may be created via slight alterations and modifications using the technical content disclosed above without departing from the scope of the technical solution of the present disclosure, and such summary alterations, equivalent changes and modifications of the foregoing embodiments are to be viewed as being within the scope of the technical solution of the present disclosure.

1. A method for detecting noise bursts, comprising:
partitioning a section of speech signals to be detected into a plurality of speech frames, and performing the following in each of the plurality of speech frames:
Fast Fourier Transform (FFT) processing in frequency-domain, afterwards computing across an entire frequency range, an energy value corresponding to each of the frequency point;
utilizing the computed energy value corresponding to each of the frequency point to compute a mean energy value of the speech frame across the entire frequency range;
computing a low frequency range mean energy value for the speech frame over the low frequency range;
using a clustering algorithm, performing clustering analysis on the low frequency range mean energy value over the plurality of speech frames in the section of speech signals;
determining a range of strong energy value based on the clustering analysis result;
detecting whether the mean energy value in each of the plurality of speech frames across the entire frequency range falls within the range of strong energy value;
if it has been detected that the mean energy value in at least one speech frame out of the plurality of speech frames in the section of speech signals falls within the range of strong energy value:
confirming or indicating that the section of speech signals to be detected has a noise burst; otherwise, confirming or indicating that the section of speech signals to be detected does not have a noise burst.

2. The method according to claim 1, wherein the partitioning of the section of speech signals to be detected into the plurality of speech frames, comprises:
adding a window width to each of the plurality of speech frames, wherein the window width is preset to accommodate a lateral shift movement of each speech frame over time during the partitioning of the section of speech signals into the plurality of speech frames.

3. The method according to claim 1, wherein the computing of the energy value in frequency domain corresponding to each of the frequency point across the entire frequency range, comprises:
computing a logarithmic value of an amplitude corresponding to each frequency point across the entire frequency range of the speech frame;
setting the computed logarithmic value of the amplitude corresponding to each frequency point of as the energy value corresponding to the frequency point.

4. The method according to claim 1, wherein the computing of the mean energy value of the speech frame across the entire frequency range, comprises:
summing the energy value corresponding to each frequency point across the entire frequency range of the speech frame to obtain a first computation result;
dividing the first computation result by the total number of frequency points in the entire frequency range to obtain the mean energy value of the speech frame across the entire frequency range.

5. The method according to claim 1, wherein the computing of the low frequency range mean energy value in the speech frame, comprises:
summing the energy value corresponding to each frequency point over a preset low frequency range in the speech frame to obtain a low frequency energy sum value;
dividing the low frequency energy sum value by the total number of frequency points in the preset low frequency range to obtain the low frequency range mean energy value of the speech frame.

6. The method according to claim 1, wherein the clustering analysis comprises the following steps:
step 1: randomly selecting any two low frequency range mean energy values out of the plurality of the speech frames to be a first and a second current clustering centers, respectively, wherein the first and the second current cluster centers are utilized to establish a first cluster and a second cluster, respectively, such that the first cluster comprises corresponding low frequency range mean energy values which form the shortest distance to the first current cluster center, and the second cluster comprises corresponding low frequency range mean energy values which form the shortest distance to the second current cluster center;
step 2: wherein the establishing of the respective first cluster and the second cluster comprising:
for each of the speech frames, computing in absolute values, a first corresponding distance by taking a difference of energy values between the first current cluster center and the low frequency range mean energy value corresponding to a first speech frame, and computing in absolute values, a second corresponding distance by taking a difference of energy values between the second current cluster center and the low frequency range mean energy value corresponding to the same first speech frame;
subsequent to the computing, sorting the low frequency range mean energy value of the first speech frame to belong one of the first cluster or the second cluster by comparing the first corresponding distance with the second corresponding distance:
if the first corresponding distance is shorter, the low frequency range mean energy value of the first speech frame belongs to the first cluster, if the second corresponding distance is shorter, the low frequency range mean energy value of the first speech frame belongs to the second cluster, if the first corresponding distance being the same as the second corresponding distance, clustering analysis is completed and reporting pending low frequency range mean energy values in the respective first and the second clusters as a result of the clustering analysis;
repeat operations in the above step 2 to continue computing in absolute values, the first corresponding distance and the second corresponding distance by taking a difference of energy values between the low frequency range mean energy value corresponding to a subsequent speech frame with the respective first current cluster center and the second current cluster center, and sorting the low frequency range mean energy value of the subsequent speech frame to one of the respective first cluster and the second cluster based on a shorter distance to the first current cluster center or to the second current cluster center, until all the low frequency range mean energy values in all remaining speech frames have been computed by the operations in the above step 2;
step 3: separately and respectively averaging all the low frequency range mean energy values in the first cluster and in the second cluster to yield a pair of first average low frequency range mean energy value and a second average low frequency range mean energy value, and
comparing the pair of the respective first average low frequency range mean energy value and the second average low frequency range mean energy value to the first and the second current clustering centers:
if the pair of the first and the second average low frequency range mean energy value is identical to, or within an error limit of the energy value of the first and the second current clustering centers, the clustering analysis is completed and reporting pending low frequency range mean energy values in the respective first and the second clusters as a result of the clustering analysis,
otherwise, setting the respective first average low frequency range mean energy value and the second average low frequency range mean energy value being the first and the second current clustering centers, and repeating the clustering analysis operations in step 2 until the pair of the first and the second average low frequency range mean energy value is identical to, or within an error limit of the energy value of the first and the second current clustering centers.

7. The method according to claim 6, wherein the determining of the range of strong energy value based on the clustering results, comprises:
selecting from one of the first and the second clusters, a cluster having a higher average low frequency range mean energy value as a selected cluster; and
establishing the range of strong energy value by taking all the mean energy values over the low frequency range or a portion of the mean energy values over the low frequency range in the selected cluster as the range of strong energy value.

8. An device for detecting noise bursts, comprises at least a processor operating in conjunction with a memory and a plurality of units, wherein the plurality of units comprise:
a partition unit which performs the function of partitioning a section of speech signals to be detected into a plurality of speech frames;
a processing unit which performs the functions of Fast Fourier Transform (FFT) processing in frequency-domain, afterwards computing across an entire frequency range, an energy value corresponding to each of the frequency point;
a computation unit which performs the functions of utilizing the computed energy value corresponding to each of the frequency point to compute a mean energy value of the speech frame across the entire frequency range; computing a low frequency range mean energy value El over the low frequency range for the speech frame;
a cluster unit using a clustering algorithm, performs the functions of performing clustering analysis on the low frequency range mean energy value over the plurality of speech frames in the section of speech signals; and determining a range of strong energy value based on the clustering analysis result;
a detection unit which performs the functions of detecting whether the mean energy value in each of the plurality of speech frames across the entire frequency range falls within the range of strong energy value; if it has been detected that the mean energy value in at least one speech frame out of the plurality of speech frames in the section of speech signals falls within the range of strong energy value:
confirming or indicating that the section of speech signals to be detected has a noise burst; otherwise,
confirming or indicating that the section of speech signals to be detected does not have a noise burst.

9. The device according to claim 8, wherein the partitioning unit's partitioning of the section of speech signals to be detected into the plurality of speech frames, comprises:
adding a window width to each of the plurality of speech frames, wherein the window width is preset to accommodate a lateral shift movement of each speech frame over time during the partitioning of the section of speech signals into the plurality of speech frames.

10. The device according to claim 8, wherein the processing unit's computing of the energy value in frequency domain corresponding to each of the frequency point across the entire frequency range, comprises:
computing a logarithmic value of an amplitude corresponding to each frequency point across the entire frequency range of the speech frame;
setting the computed logarithmic value of the amplitude corresponding to each frequency point of as the energy value corresponding to the frequency point.

11. The device according to claim 8, wherein computing of the mean energy value of the speech frame across the entire frequency range, comprises:
summing the energy value corresponding to each frequency point across the entire frequency range of the speech frame to obtain a first computation result;
dividing the first computation result by the total number of frequency points in the entire frequency range to obtain the mean energy value of the speech frame across the entire frequency range;
wherein the computing of the low frequency range mean energy value in the speech frame, comprising:
summing the energy value corresponding to each frequency point over a preset low frequency range in the speech frame to obtain a low frequency energy sum value;
dividing the low frequency energy sum value by the total number of frequency points in the preset low frequency range to obtain the low frequency range mean energy value of the speech frame.

12. The device according to claim 8, wherein the cluster unit's performing the clustering analysis comprises the following steps:
step 1: randomly selecting any two low frequency range mean energy values out of the plurality of the speech frames to be a first and a second current clustering centers, respectively, wherein the first and the second current cluster centers are utilized to establish a first cluster and a second cluster, respectively, such that the first cluster comprises corresponding low frequency range mean energy values which form the shortest distance to the first current cluster center, and the second cluster comprises corresponding low frequency range mean energy values which form the shortest distance to the second current cluster center;
step 2: wherein the establishing of the respective first cluster and the second cluster comprising:
for each of the speech frames, computing in absolute values, a first corresponding distance by taking a difference of energy values between the first current cluster center and the low frequency range mean energy value corresponding to a first speech frame, and computing in absolute values, a second corresponding distance by taking a difference of energy values between the second current cluster center and the low frequency range mean energy value corresponding to the same first speech frame;
subsequent to the computing, sorting the low frequency range mean energy value of the first speech frame to belong one of the first cluster or the second cluster by comparing the first corresponding distance with the second corresponding distance:
if the first corresponding distance is shorter, the low frequency range mean energy value of the first speech frame belongs to the first cluster, if the second corresponding distance is shorter, the low frequency range mean energy value of the first speech frame belongs to the second cluster, if the first corresponding distance being the same as the second corresponding distance, clustering analysis is completed and reporting pending low frequency range mean energy values in the respective first and the second clusters as a result of the clustering analysis;
repeat operations in the above step 2 to continue computing in absolute values, the first corresponding distance and the second corresponding distance by taking a difference of energy values between the low frequency range mean energy value corresponding to a subsequent speech frame with the respective first current cluster center and the second current cluster center, and sorting the low frequency range mean energy value of the subsequent speech frame to one of the respective first cluster and the second cluster based on a shorter distance to the first current cluster center or to the second current cluster center, until all the low frequency range mean energy values in all remaining speech frames have been computed by the operations in the above step 2;
step 3: separately and respectively averaging all the low frequency range mean energy values in the first cluster and in the second cluster to yield a pair of first average low frequency range mean energy value and a second average low frequency range mean energy value, and
comparing the pair of the respective first average low frequency range mean energy value and the second average low frequency range mean energy value to the first and the second current clustering centers:
if the pair of the first and the second average low frequency range mean energy value is identical to, or within an error limit of the energy value of the first and the second current clustering centers, the clustering analysis is completed and reporting pending low frequency range mean energy values in the respective first and the second clusters as a result of the clustering analysis,
otherwise, setting the respective first average low frequency range mean energy value and the second average low frequency range mean energy value being the first and the second current clustering centers, and repeating the clustering analysis operations in step 2 until the pair of the first and the second average low frequency range mean energy value is identical to, or within an error limit of the energy value of the first and the second current clustering centers.

13. The device according to claim 8, wherein the clustering unit's determining of the range of strong energy value based on the clustering results, comprises:
selecting from one of the first and the second clusters, a cluster having a higher average low frequency range mean energy value as a selected cluster; and
establishing the range of strong energy value by taking all the mean energy values over the low frequency range or a portion of the mean energy values over the low frequency range in the selected cluster as the range of strong energy value.

14. A non-transitory computer-readable storage medium having stored thereon, a computer program having at least one code section being executable by a machine for causing the machine to perform steps comprising:
partitioning a section of speech signals to be detected into a plurality of speech frames, and performing the following in each of the plurality of speech frames:
Fast Fourier Transform (FFT) processing in frequency-domain, afterwards computing across an entire frequency range, an energy value corresponding to each of the frequency point;
utilizing the computed energy value corresponding to each of the frequency point to compute a mean energy value of the speech frame across the entire frequency range;
computing a low frequency range mean energy value for the speech frame over the low frequency range;
using a clustering algorithm, performing clustering analysis on the low frequency range mean energy value over the plurality of speech frames in the section of speech signals;
determining a range of strong energy value based on the clustering analysis result;
detecting whether the mean energy value in each of the plurality of speech frames across the entire frequency range falls within the range of strong energy value;
if it has been detected that the mean energy value in at least one speech frame out of the plurality of speech frames in the section of speech signals falls within the range of strong energy value:
confirming or indicating that the section of speech signals to be detected has a noise burst; otherwise, confirming or indicating that the section of speech signals to be detected does not have a noise burst.

15. The non-transitory computer-readable storage medium according to claim 14, wherein the partitioning of the section of speech signals to be detected into the plurality of speech frames, comprises:
adding a window width to each of the plurality of speech frames, wherein the window width is preset to accommodate a lateral shift movement of each speech frame over time during the partitioning of the section of speech signals into the plurality of speech frames.

16. The non-transitory computer-readable storage medium according to claim 14, wherein the computing of the energy value in frequency domain corresponding to each of the frequency point across the entire frequency range, comprises:
computing a logarithmic value of an amplitude corresponding to each frequency point across the entire frequency range of the speech frame;
setting the computed logarithmic value of the amplitude corresponding to each frequency point of as the energy value corresponding to the frequency point.

17. The non-transitory computer-readable storage medium according to claim 14, wherein the computing of the mean energy value of the speech frame across the entire frequency range, comprises:
summing the energy value corresponding to each frequency point across the entire frequency range of the speech frame to obtain a first computation result;
dividing the first computation result by the total number of frequency points in the entire frequency range to obtain the mean energy value of the speech frame across the entire frequency range.

18. The non-transitory computer-readable storage medium according to claim 14, wherein the computing of the low frequency range mean energy value in the speech frame, comprises:
summing the energy value corresponding to each frequency point over a preset low frequency range in the speech frame to obtain a low frequency energy sum value;
dividing the low frequency energy sum value by the total number of frequency points in the preset low frequency range to obtain the low frequency range mean energy value of the speech frame.

19. The non-transitory computer-readable storage medium according to claim 14, wherein the clustering analysis comprises the following steps:
step 1: randomly selecting any two low frequency range mean energy values out of the plurality of the speech frames to be a first and a second current clustering centers, respectively, wherein the first and the second current cluster centers are utilized to establish a first cluster and a second cluster, respectively, such that the first cluster comprises corresponding low frequency range mean energy values which form the shortest distance to the first current cluster center, and the second cluster comprises corresponding low frequency range mean energy values which form the shortest distance to the second current cluster center;
step 2: wherein the establishing of the respective first cluster and the second cluster comprises:
for each of the speech frames, computing in absolute values, a first corresponding distance by taking a difference of energy values between the first current cluster center and the low frequency range mean energy value corresponding to a first speech frame, and computing in absolute values, a second corresponding distance by taking a difference of energy values between the second current cluster center and the low frequency range mean energy value corresponding to the same first speech frame;
subsequent to the computing, sorting the low frequency range mean energy value of the first speech frame to belong one of the first cluster or the second cluster by comparing the first corresponding distance with the second corresponding distance:
if the first corresponding distance is shorter, the low frequency range mean energy value of the first speech frame belongs to the first cluster, if the second corresponding distance is shorter, the low frequency range mean energy value of the first speech frame belongs to the second cluster, if the first corresponding distance being the same as the second corresponding distance, clustering analysis is completed and reporting pending low frequency range mean energy values in the respective first and the second clusters as a result of the clustering analysis;
repeat operations in the above step 2 to continue computing in absolute values, the first corresponding distance and the second corresponding distance by taking a difference of energy values between the low frequency range mean energy value corresponding to a subsequent speech frame with the respective first current cluster center and the second current cluster center, and sorting the low frequency range mean energy value of the subsequent speech frame to one of the respective first cluster and the second cluster based on a shorter distance to the first current cluster center or to the second current cluster center, until all the low frequency range mean energy values in all remaining speech frames have been computed by the operations in the above step 2;
step 3: separately and respectively averaging all the low frequency range mean energy values in the first cluster and in the second cluster to yield a pair of first average low frequency range mean energy value and a second average low frequency range mean energy value, and
comparing the pair of the respective first average low frequency range mean energy value and the second average low frequency range mean energy value to the first and the second current clustering centers:
if the pair of the first and the second average low frequency range mean energy value is identical to, or within an error limit of the energy value of the first and the second current clustering centers, the clustering analysis is completed and reporting pending low frequency range mean energy values in the respective first and the second clusters as a result of the clustering analysis,
otherwise, setting the respective first average low frequency range mean energy value and the second average low frequency range mean energy value being the first and the second current clustering centers, and repeating the clustering analysis operations in step 2 until the pair of the first and the second average low frequency range mean energy value is identical to, or within an error limit of the energy value of the first and the second current clustering centers.

20. The non-transitory computer-readable storage medium according to claim 19, wherein the determining of the range of strong energy value based on the clustering results, comprises:
selecting from one of the first and the second clusters, a cluster having a higher average low frequency range mean energy value as a selected cluster; and
establishing the range of strong energy value by taking all the mean energy values over the low frequency range or a portion of the mean energy values over the low frequency range in the selected cluster as the range of strong energy value.
